(19) United States
(12) Patent Application Publication
(10) Pub. No.: US 2010/0303997 A1
(43) Pub. Date: Dec. 2, 2010

(54) PROCESS AND METHOD FOR CREATING NO-STARCH OR LOW-STARCH, HIGH-FIBER DOUGH AND FOOD COMPOSITIONS USING CONTROLLED HYDRATION OF MUCILAGENOUS HYDROCOLLOIDS

(76) Inventor: DAVID JOHN FULTON, Wimberley, TX (US)

Correspondence Address: Andrews Kurth LLP, 111 Congress Avenue, Suite 1700, Austin, TX, 78701, US

(21) Appl. No.: 12/789,280

(22) Filed: May 27, 2010

Related U.S. Application Data
(60) Provisional application No. 61/182,608, filed on May 29, 2009.

(51) Int. Cl. A21D 8/02

(52) U.S. Cl. 426/601; 426/615

(57) ABSTRACT

A process to use partial hydration of certain mucilaginous hydrocolloids to produce a starch-free, high-fiber baked food product is disclosed. The method includes blending a fiber component comprising soluble, non-digestible hydrocolloid fibers, a protein component, a fat component and at least one additive to form a dough, and baking the dough to allow the internal network to encapsulate hot gases released during the baking process to inflate the dough into a baked food product. The water addition is controlled in the blending process so that the soluble hydrocolloid fibers are partially hydrated to form an elastic internal network of mucilage, The dough is free from digestible starch and gluten and is baked without the use of yeast.

### RELATED APPLICATIONS

This application claims the priority of U.S. Provisional Patent Application No. 61/182,608, filed on May 29, 2009, which is incorporated herein by reference in its entirety.

### TECHNICAL FIELD

The present invention generally relates to a method for controlled hydration of mucilaginous hydrocolloids for food compositions and, in particular, to high-fiber food compositions with minimal amount of digestible carbohydrates.

### BACKGROUND

It is essential to create a new category of baked foods that do not significantly contain starch or flour components and that provide satiety and are acceptable substitutes for the traditional baked foods made from digestible flour, starch and sweetener components that metabolize into high calorie glucose to allow better blood sugar management and not challenge the endocrine system. Hydrocolloids and fiber do not digest into glucose and do not require insulin to metabolize. By replacing traditional baked snack foods with acceptable substitute baked foods that do not significantly digest into glucose and do not require insulin to metabolize we can offer a safe and effective solution to better manage blood glucose in diabetics and others with compromised insulin response as well as provide an alternative snack to assist weight-loss and many other health conditions that benefit from restricted sugar and starch consumption.

There is substantial clinical evidence to suggest that sugar consumption is a major contributing factor in rapidly increasing obesity, diabetes and heart disease as well as many other health problems. These health problems are challenging an aging population as well as an escalating number of youth. The growing amount of public health problems are over-burdening limited medical and government resources. There is a growing body of evidence to implicate sugar and other substances that excessively and often quickly metabolize into glucose as a major factor in the exponential growth of health problems. Many physicians and health professionals believe that reducing sugar consumption can substantially improve and possibly eliminate many health problems. It has been proven that the inflammation caused by digesting sugar can cause and contribute to the complications of heart disease, cancer, Alzheimer and rheumatoid arthritis, Restricted sugar consumption is advised by physicians to treat many digestive disorders such as Crohn's Disease, Candida yeast problems, and irritable bowel. Behavioral issues in children such as attention deficit disorder, hyperactivity disorder and a wide spectrum of autistic disorders and conditions of the nervous system such as psychosis and multiple sclerosis have seen significant improvement by restriction of substances that when eaten digest to glucose. Sugar consumption has been directly connected to obesity and many hospitals and school systems have restricted the availability and access to sugar based snacks and drinks such as sodas and candy.

Starch metabolizes to glucose with the same efficacy as sugar. Starch and sugar are equivalent digestible carbohydrates with equal calories and insulin requirements. Sugar and starch place the same glycemic load on the human body. There is substantial effort to reduce public sugar consumption. These efforts involve substitute sweeteners and foods to offer a safe alternative to assist with reducing public dependence on sugar and reduce the recognized risk of excessive consumption of sucrose table sugar, fructose and high fructose corn syrup. There has not been the same focus placed on finding acceptable substitutes for foods made with starch and other ingredients that when eaten metabolize equivalent to sugar with the same glycemic impact on blood glucose and same resulting health complications now associated with sugar consumption.

There is a growing demand for foods that do not contain allergenic gluten proteins as found in wheat flour. These gluten-free substitute foods attempt to mimic the taste sensation of traditional baked food products using gummy substances such as Xanthan gum and gluten free flours to create the internal membrane structure associated with baked foods. Common alternative flours used in gluten free foods include oat, rice, potato, tapioca, arrowroot, corn and others. Substantial portions of these flours are starch carbohydrates that still digested into glucose with the identical impact on the endocrine system as sugar. The need to find a safe replacement to reduce digestible starch consumption from baked foods is as important as the growing efforts to reduce sugar consumption.

High fiber diet benefits the body by improving the regulation of bowel function, and reducing gastrointestinal disorders and serum cholesterol levels. High fiber intake has also been associated with a decreased incidence of certain types of cancer. High-fiber-low-carbohydrate diets have been widely used in weight loss programs.

Current high-fiber, low-carbohydrate baked consumables and various combinations of high-fiber, low-carbohydrate baked consumables contain a significant amount of flour in order to maintain desired organoleptic properties, such as mouth feel, crumb, dentation, and taste profile. A major component of regular flour is starch, a polysaccharide carbohydrate that can be easily broken down into glucose by enzymes in the digestive tract of a human body. For patients with certain metabolic disorders, such as type-2 diabetes, ingestion of starch may lead to hyperglucermia that contributes substantially to the pathogenesis of the long-term microvascular and macrovascular complications of the disorder. Therefore, there exists a need for baked goods with high fiber content, a pleasant taste and texture, and minimal amount of digestible carbohydrates.

Wheat that contains allergenic gluten proteins is most commonly used in baking due to its superior properties of gluten which create a network of protein strands. However if wheat gluten proteins can not be used, other forms of flour such as rice, corn, potato, tapioca, spelt and other substitute flours all containing varying amounts of protein, fiber and starch can be used with varying success. These flours are often combined in gluten-free baking to create better properties similar to the gluten protein of wheat that they are being used to replace. The starch in these replacement flours contains starch mucilage as a binder. Even though a 1.5% weight/volume ratio of psyllium mucilage exhibits binding properties that are superior to a 10% weight/volume ratio of starch mucilage. Hydrocolloid Gums such as Xanthan and Gaur Gum are added to substitute for the missing elastic gluten proteins to create rubbery pockets to encapsulate hot gases to accomplish the creation of the network similar to baked foods made from wheat gluten proteins. These gums are only employed in these gluten free baked foods with the use of starch in the flour component in order to create the glue to bind and anchor the elastic proteins, gum and fiber into a network to capture hot gases. Other ingredients such as fat and dough conditioners contribute to the quality of the gluten-free final baked product. The starch component of these flours is the essential glue to bind the connection points of the network formed by the proteins, fiber and gum.

The accepted method for creating baked foods is to use flours that contain wheat gluten and substitute flours that do not contain wheat gluten that still have a digestible carbohydrate flour or starch component that when consumed metabolizes into glucose with the subsequent impact as sucrose sugar on the body. In traditional baked foods the flour component forms the final stretched network of proteins, fibers and starch we associate with the organoleptic sensations of baked foods. Hot gasses in the baking process stretch the protein and fiber portion. Fat and dough conditioners as well as moisture contribute to the elasticity of the strands and their ability to entrain gases. The starch component of the flour when wet acts as a glue to connect and anchor the stretched protein and fiber strands to form the interlocking network. The quantity and properties of the proteins, fiber and starch determine the form and characteristics of the solidified final network of strands that we associate with the structure of baked foods that vary from soft and spongy to crisp and crumbly. They all use this method to glue together proteins and fibers with starch carbohydrates. These starch carbohydrates digest to glucose.

This invention replaces the traditional method of using starch to glue together strands of protein and fiber and instead uses a controlled wetting process of mucilaginous hydrocolloids in varying degrees to create sticky chain molecules that attach and anchor the interconnecting points of the protein and fiber strands, which do not have the inherent stickyness of starch, to form a stable network structure of a baked food with no need for starch. This process allows the creation of baked food that is comprised almost entirely of fiber and protein without the need for starch and allows for the creation of baked foods that have no significant impact on blood glucose. Starch is a high calorie substance that digests to glucose. Fiber and hydrocolloids do not digest to glucose. This controlled wetting process of mucilaginous hydrocolloids yields a variety of traditional baked food compositions without the need for starch. Replacing starch with partially wetted mucilaginous hydrocolloids and fiber allows for a significant reduction in glucose production, insulin secretion and glucose calories.

U.S. Pat. No. 5,955,123 recommends adding smooth texture psyllium husk in the form of Metamucil.RTM to traditional baked foods as a method to reduce digestible carbohydrates and increase healthy fiber. The Patent states that cookies or other baked compositions have been identified as a useful way to introduce psyllium into the diet. However, attempts to incorporate psyllium into baked goods have historically met with difficulty due to the extremely hydrophilic nature of psyllium. If the psyllium is incorrectly hydrated before the compositions are baked, an undesirable product results.

A number of methods have been suggested for obviating the problems associated with incorporating psyllium into baked compositions. U.S. Pat. No. 5,095,008 discloses the manipulation of flour, starch and the order of ingredients in addition to “tying up” the water in the cookie dough system comprised of other ingredients including starch and other digestible carbohydrates prior to mixing in psyllium. This Patent states psyllium cannot be used to simply substitute for the entire flour or starch component conventionally used in cookie compositions. If this were done, the result would be a crumbly cookie that would not stay in one piece. Furthermore, the psyllium generally cannot be added in addition to the typical ingredient levels for conventional cookie compositions. This would prevent inclusion of necessary levels of key cookie components. Thus, the cookies of the present composition are made with psyllium and a reduced level of flour. U.S. Pat, No, 5,126,150 discloses baked cookie compositions where the psyllium is first coated with calcium lactate and optionally a gelatin, prior to mixing. U.S. Pat. No. 5,384,136 teaches that psyllium cannot be routinely incorporated into dough products such as bread. Lai et al. further teaches that to overcome the problems with making psyllium-enriched dough products, the psyllium must first be cold extruded to form pellets and then prewetted. U.S. Pat. No. 5,015,486 states that it is necessary to add a second gum such as guar or bean gum to psyllium to successfully make psyllium-containing microwavable muffins, Still other Patents, such as U.S. Pat. No. 6,248,387, utilize the health benefits of psyllium fiber in a gelatinized and extruded snack form that attempts to create a bake like snack without the air pocket network that characterizes a baked food. An extrusion is not the same as a baked food with an expanded network of protein and fiber as in traditional baked foods. All patents for a baked food product with an internal network of protein and fiber that has been expanded by hot gases in the baking process require some form of digestible carbohydrate starch and many require a yeast process to rise.

### SUMMARY

A unique process is provided using the controlled release and incorporation of bound water and free water to partially hydrate psyllium and similar mucilaginous hydrocolloids to form baked foods similar with comparable organoleptic characteristics to traditional baked foods without the addition of starch, digestible carbohydrates or yeast. The disclosed invention allows the complete elimination of starch-based flours from the baking process.

A process for the controlled wetting of mucilaginous hydrocolloids such as milled psyllium husk flour and milled psyllium seed flour to create a variety of low-starch, high-fiber food product is disclosed. The low-starch, high-fiber food product has a significantly lower starch and digestible carbohydrate content than a comparable product made from conventional flour such as wheat, rice, oat, potato, soy, corn, tapioca or combinations of other predominantly starch based flours.

The unique food invention embodied in this patent provides a solution for the need for baked foods that do not use digestible carbohydrates to create the network of elastic fibers and air pockets long associated with traditional baked foods such as cookies, cakes, bread, muffins and other baked foods. This unique process uses the mucilaginous characteristics of certain hydrocolloids such as in the preferred embodiment, psyllium in a partially wetted state to create a network of sticky long change carbohydrates, protein and fiber without the need for starch mucilage to bind or glue the anchor points of the network.

The method of the present invention allows partially hydrated mucilaginous hydrocolloid fibers to form a network of fibers and air pockets in baked foods similar to traditional baked foods that use starch. These mucilaginous hydrocolloid fibers then solidify into a stable structure of air pockets entrained within a network of fibers in a baked food very similar to traditional baked foods but without starch or gluten protein. This baking process allows for the creation of baked foods with organaleptic characteristics very similar to traditional baked foods that can be consumed with no significant impact on blood glucose. Mucilaginous hydrocolloids such as psyllium seed and psyllium husk fiber do not digest to glucose since the human body does not have enzymes to digest these fibers into glucose. Using this unique method, it is possible to create baked foods that do not require starch to form internal fiber networks. Such mucilaginous hydrocolloid baked foods allow consumption of a baked food that is made from fiber instead of digestible carbohydrates. This partially hydrated mucilaginous hydrocolloid does not require insulin to metabolize and will not contribute to elevation in blood sugar levels.

By using various types of mucilaginous hydrocolloids in varying amounts and specific liquid factions in various amounts and various entraining mediums and combinations as well as limited free water, it is possible to create a wide variety of traditional baked foods from mucilaginous hydrocolloids similar in texture and taste to traditional baked foods but these mucilaginous hydrocolloid baked foods are made nearly completely from non-digestible fiber instead of digestible carbohydrates such as starch that digest to glucose and require insulin to metabolize.

The very restricted and strictly controlled limited wetting of the mucilaginous hydrocolloid fibers is a factor of the degree of exposure to the wetting agent during the formulation process. For example if one adds water freely as in traditional baked foods and in quantities greater than specifically allowed to only partially wet the mucilage of the hydrocolloid and as has been demonstrated in many other patents, the mucilage will become gelatinous, dense, over-saturated and may even harden in the baking process to a solid dense structure that is undesirable for consumption. Being highly absorptive, the mucilage in hydrocolloids will fully convert to a gelatinous state when allowed to freely absorb liquid. Often fully hydrated mucilage in hydrocolloids will also off gas undesirable tastes. Excessively hydrated mucilage in hydrocolloids creates a final baked product of unacceptable taste and texture for food consumption.

Some patents endeavor to circumvent this problem by converting the mucilage in hydrocolloids by freely adding water or liquid until completely saturated and then extruding the final product into a bar type food that is far from a traditional baked food that by it's nature is comprised of an internal network of air pockets. This is not a traditional baked food but an extrusion similar to pasta. There is no significant air pocket structure in fully hydrated and then extruded bar of mucilage that is then enrobed with other ingredients to add taste and texture. This is not the method we utilize.

The controlled wetting process of the mucilaginous hydrocolloid ingredients to produce baked food items happens by allowing only brief, extremely limited access to the moisture component as limited free water and constrained forms such as the small amount of water in butter, coconut oil and butter substitutes that have a high fat content but a small percentage of highly constrained water. Another wetting agent is the liquid faction in egg albumin protein. The egg albumin and fat slow the absorption of the water portion but allow the dry ingredients of the mucilaginous hydrocolloid and other factions to be mixed, shaped and molded as traditional dough. Instead of adding water or dairy liquids or other liquids freely in large quantities to mix the dough as employed in starch-based flour baking and has been attempted in prior efforts, only a very small amount of free water with or as a faction of more a viscous solution to slow absorption but provide lubrication is added. The exposure time is also critical as the longer the mucilaginous hydrocolloid is exposed to the wetting agent prior to baking the more it will hydrate and gel which will effect the texture of the final baked food item. By using this process of only slightly wetting of the mucilage hydrocolloid fibers the fibers are wetted far less completely and much more slowly allowing them to stretch and expand into a sticky network that will capture hot gases in the baking process and then solidify into a fully baked state without collapsing, This process is unique to working with mucilaginous hydrocolloids as this controlled wetting does not hydrate the mucilaginous hydrocolloid completely but rather only specifically to the point of elasticity to form the long chain carbohydrate network and sticky anchor points but not fully to the gelatinous state often associated with adding a liquid faction to mucilaginous hydrocolloids. When baked, this process of forming an elastic membrane of partially wetted mucilage hydrocolloid fibers expands to capture hot gasses and will solidify into mucilage hydrocolloid network of air pockets that closely duplicate the air pocket network that forms from using starch with various proteins and fiber in traditional baked foods.

This delayed, incomplete wetting of the mucilaginous hydrocolloid to a limited amount combined with the action of fat and protein to restrict absorption of water and the amount and nature of the fiber being either soluble or insoluble and dough conditioners such as whey protein, whey protein isolate and inulin as well as glaciating substances such as erythritol, allow one skilled in the art to develop compositions with varying degrees of tactile and organoleptic properties consistent with traditional baked foods that form air pockets as part of their taste profile such as cookies, cakes, muffins, bread, bagel chips, etc. that when eaten masticate with desirable mouth feel and taste characteristics. This also limits the amount of mucilaginous hydrocolloid required which allows the flavor impact from the hydrocolloid substance to be easily managed with other flavor and masking agents. The small amount of mucilaginous hydrocolloid required to form the network due to it's highly absorptive nature and superior binding properties compared to starch mucilage, limits the amount of hydrocolloid needed to a safe dietary amount for consumption that does not cause gastric upset. By controlling the elasticity of the mucilaginous hydrocolloid fibers using controlled wetting of varying degrees in conjunction with other conditioning ingredients it is possible to form and control the size and shape of air pockets in baked foods, degree of rise or spread, rigidity of the fibers that create the air pockets and other bake item category specific characteristics in the final baked food product. One can create a variety of taste and organoleptic sensations of consistent and acceptable quality for commercial sale to the public of baked food substitutes that have no or almost no impact on blood glucose as alternatives for traditional baked foods normally made with starch binders and gluten proteins.

In one embodiment, the low-starch, high-fiber food product is dough. The dough contains 3-30% protein by weight, 10-40% fiber by weight, 1.0-40% fat by weight, at least one additive in the amount of 1-30% by weight, and 10-40% water by weight. The fiber and protein component of the dough provide bulk to support a structure of a food product, and the dough has a digestible starch content of 15% or less by weight and a digestible carbohydrate content of 17% or less by weight. In another embodiment, the dough has a digestible starch content of 10% or less by weight and a digestible carbohydrate content of 12% or less by weight. In another embodiment, the dough has a digestible starch content of 5% or less by weight and a digestible carbohydrate content of 7% or less by weight. In another embodiment, the dough has a digestible starch content of 2% or less by weight and a digestible carbohydrate content of 4% or less by weight. In another embodiment, the dough has a digestible starch content of 1% or less by weight and a digestible carbohydrate content of 2% or less by weight. In another embodiment, the fiber is psyllium fiber. In another embodiment, the fiber is a mixture of coconut fiber and psyllium fiber. In yet another embodiment, the psyllium fiber is a mixture of ground whole psyllium seed and ground psyllium husk, and the additive is erythritol or Rebaudioside A or inulin.

In another embodiment, the low-starch, high-fiber food product is a baked food product. The baked food product contains 3-30% protein by weight, 10-40% fiber by weight, 10-40% fat by weight, at least one additive in the amount of 1-60% by weight, and 2-10% water by weight The fiber and protein components provide bulk to support a structure of the baked food product, which has a digestible starch content of 15% or less by weight and a digestible carbohydrate content of 17% or less by weight. In one embodiment, the food product has a digestible starch content of 10% or less by weight and a digestible carbohydrate content of 12% or less by weight. In another embodiment, the food product has a digestible starch content of 5% or less by weight and a digestible carbohydrate content of 7% or less by weight. In another embodiment, the food product has a digestible starch content of 2% or less by weight and a digestible carbohydrate content of 4% or less by weight. In another embodiment, the food product has a digestible starch content of 1% or less by weight and a digestible carbohydrate content of 2% or less by weight. In another embodiment, the fiber is psyllium fiber. In another embodiment, the fiber is a mixture of coconut fiber and psyllium fiber. In yet another embodiment, the psyllium fiber is a mixture of ground whole psyllium seed and ground psyllium husk, and the additive is erythritol or Rebaudioside A or inulin.

In another embodiment, the low-starch, high-fiber food product is a baking mix. The baking mix contains 5-30% protein by weight, 10-40% fiber by weight, 1-20% fat by weight, and at least one additive in the amount of 1-60% by weight. The baking mix has a digestible starch content of 15% or less by weight and a digestible carbohydrate content of 17% or less by weight. In one embodiment, the baking mix has a digestible starch content of 10% or less by weight and a digestible carbohydrate content of 12% or less by weight. In another embodiment, the baking mix has a digestible starch content of 5% or less by weight and a digestible carbohydrate content of 7% or less by weight. In another embodiment, the baking mix has a digestible starch content of 2% or less by weight and a digestible carbohydrate content of 4% or less by weight. In another embodiment, the baking mix has a digestible starch content of 1% or less by weight and a digestible carbohydrate content of 2% or less by weight. In another embodiment, the fiber is psyllium fiber. In another embodiment, the fiber is a mixture of coconut fiber and psyllium fiber. In yet another embodiment, the psyllium fiber is a mixture of ground whole psyllium seed and ground psyllium husk, and the additive is erythritol or Rebaudioside A or inulin.

Also disclosed is a method for making low-starch, high-fiber dough. The method includes: combining a fiber with a protein component, a fat component, and at least one additive, and blending the combined materials into a dough with a uniform texture, wherein the naturally existing water in the fat component and the protein component serve as the major wetting agent for the fiber. In one embodiment, the fiber is psyllium fiber and the protein component comprises freshly prepared whole eggs or egg white.

Also disclosed is a method for using psyllium fiber as a low-starch nutritional supplement for patients in need of controlling carbohydrate intake. The method includes: mixing psyllium fiber with a low-starch fat component, a low-starch protein component and at least one low-starch food additive to form a dough; and baking the dough to produce a bakery product, wherein the bakery product has a digestible starch content of 5% or less by weight and a digestible carbohydrate content of 7% or less by weight.

### DETAILED DESCRIPTION

A unique method to partially hydrate certain mucilaginous hydrocolloids such as milled psyllium to form no starch and low-starch, high-fiber food products is disclosed. The method disclosed to form a no starch or low-starch, high-fiber food product from mucilaginous hydrocolloids has a significantly lower starch, and digestible carbohydrate content than a comparable product made from conventional flour such as wheat, rice, oat, potato, soy, corn, tapioca or combinations of other predominantly starch based flours or baked foods with starch and digestible carbohydrate ingredients added to aid in the formation of an internal fiber network common to baked foods.

In certain embodiments, the disclosed process to use partial hydration of certain mucilaginous hydrocolloids to form no starch and low-starch, high-fiber food products has a starch content that is less than 60%, 50%, 40%, 30%, 20%, 10%, 5%, or 2% of the starch content in a comparable product made from conventional flour such as wheat, rice, oat, potato, soy, corn, tapioca or combinations of other predominantly starch based flours.

In other embodiments, the disclosed process to use partial hydration of certain mucilaginous hydrocolloids to form no starch and low-starch, high-fiber food product has a digestible carbohydrate content that is less than 60%, 50%, 40%, 30%, 20%, 10%, 5% or 2% of the starch content in a comparable product made from conventional flour such as wheat, rice, oat, potato, soy, corn, tapioca or combinations of other predominantly starch based flours.

As used hereinafter, the term “starch” refers to digestible starches only. Starches that escape digestion in the small intestine of healthy individuals, such as various kinds of resistant starches, are not digestible starches. The digestible portion of resistant starches qualifies as metabolizing into glucose and the disclosed process for use of partially hydrated mucilagenous hydrocolloids will also allow for the elimination or reduction of these digestible carbohyrate factions of resistant starches. As used hereinafter, a product or composition is considered “starch-free” if it contains 5% or less, preferably 2% or less, most preferably 1% or less digestible starch. As used hereinafter, a product or composition is considered “gluten-free” if it contains 0.5% or less, preferably 0.1% or less, most preferably 0.01% or less gluten. All the percentages used hereinafter refer to weight-to-weight percentages.

The disclosed process to use partial hydration of certain mucilaginous hydrocolloids to form no starch and low-starch, high-fiber food product has a fiber content of at least 10%. In certain embodiments, the resulting low-starch, high-fiber food product using this controlled hydration of mucilaginous hydrocolloid process has a fiber content of at least 20%. In certain other embodiments, the low-starch, high-fiber food product has a fiber content of at least 30%. In yet other embodiments, the low-starch, high-fiber food product has a fiber content of at least 40%. The ability to nearly completely replace all forms of digestible carbohydrate with fiber and certain partially hydrated mucilaginous hydrocolloids is unique to this process and replaces traditional starch bonds that form internal networks in traditional baking methods.

In one embodiment, the disclosed process to use partial hydration of certain mucilaginous hydrocolloids to form no starch and low-starch, high-fiber food products is dough. The resulting low-starch, high-fiber dough using this controlled hydration of mucilaginous hydrocolloid process, contains 10-40% fiber by weight, 3-30% protein by weight, 10-40% fat by weight, at least one additive in the amount of 1-30% by weight, and 10-40% water primarily constrained in fat or liquid protein faction. The protein and fiber content of the dough provide the bulk to support the structure of the food product produced from the dough without the need for starch bonds. The sticky bonds of the partially hydrated mucilaginous hydrocolloid connect the protein and fiber strands to capture hot expanding gas in the baking process and then form the self-supporting bread-like network common to baked foods. The dough has a digestible starch content of 15% or less by weight and a digestible carbohydrate content of 17% or less by weight. In another embodiment, the dough has a digestible starch content of 10% or less by weight and a digestible carbohydrate content of 12% or less by weight. In another embodiment, the dough has a digestible starch content of 5% or less by weight and a digestible carbohydrate content of 7% or less by weight. In another embodiment, the dough has a digestible starch content of 2% or less by weight and a digestible carbohydrate content of 4% or less by weight. In another embodiment, the dough has a digestible starch content of 1% or less by weight and a digestible carbohydrate content of 2% or less by weight.

### Fiber

The fiber can be any fiber that is free of digestible carbohydrate. As used hereinafter, a fiber with a digestible carbohydrate content of 5% (w/w) or less is considered free of digestible carbohydrate. Digestible starch is one form of digestible carbohydrate. The fiber can be a water-insoluble dietary fiber, a water-soluble dietary fiber or a mixture thereof. Examples of water-insoluble dietary fiber include, but are not limited to, psyllium fiber, cereal grain fibers such as fibers from corn, wheat, oat, rice, barley and soy, fruit fibers, vegetable fibers such as fibers from peas and legumes and potato, celluloses and modified celluloses, such as methyl cellulose, hydroxyethyl cellulose, hydroxpyropyl cellulose, carboxymethyl cellulose and other similar modified celluloses.

Examples of water-soluble dietary fiber include, but are not limited to, plant gums and plant derivatives such as inulin, gum arabic, locust bean gum, citrus pectins, low and high methoxy pectin, gum tragacanth, agar, alginates, carrageenan, xanthan gum, guar gum, alginic acid salts, gum ghatti, Irish moss, gum karia and the like. Mixtures of soluble and insoluble dietary fiber may also be employed. In certain embodiments, the baked products of the present invention contains inulin. In other embodiment, the baked products contains inulin in the amount of 1-20%, 5-20% or 10-20% by weight.

In addition to its conventional bulking, gel forming and adhesive functions, the fiber of the present invention is selected for its hydrocolloid properties. Specifically, the method of the present invention uses the partial controlled hydration of the mucilaginous hydrocolloid soluble and/or insoluble dietary fibers to form a reticular net or framework within a dough or food product, which is analogous to the binding function of starch mucilage with and without gluten and other proteins and fibers in conventional baking. A 1.5% weight/volume ratio of psyllium mucilage exhibits binding properties that are superior to a 10% weight/volume ratio of starch mucilage. In all embodiments, the amount of water within the dough is strictly controlled and limited. Specifically, water is used in controlled amounts and using controlled delivery in the mixing and baking process to partially moisten soluble hydrocolloid fibers to a sufficient degree to allow the fibers to stretch, form and adhere without allowing them to go all the way to gel formation and expansion. The amount of water as well as the method of disbursement and controlled rate of absorption of the water by entrainment in various delivery mediums and the specific soluble or insoluble hydrocolloid fiber or combination of fibers and conditioning ingredients is essential to this process. In certain embodiments, the water in the dough comes mainly from the protein source (e.g., whole egg, egg yolk, or egg white) and fat source (e.g., butter), which is enough to catalyze the adhesion process in the dough. In other words, the soluble fibers in the dough are hydrated mainly by the bound water and a strictly controlled amount of free water. In other embodiments, all the water in the dough is bound water (i.e., water from the protein source (e.g., whole egg, egg yolk, or egg white) and fat source (e.g., butter). The formation of the hydrocolloid fiber internal net is analogous to that of conventional baking, i.e. by working or kneading the dough to form a flexible, expandable three-dimensional internal membrane framework, which will allow gases to be entrained in controllable cell sizes thru conventional leavening agents or use of pressurized carbonization.

The exact amount of water needed to achieve partial hydration of the soluble fiber varies with the type of fiber and the composition of the baking mix. In certain embodiments, proper hydration of fibers can be achieved by preparing dough with a fiber-to-water (including bound and free water) weight ratio in the range of 1:0.6 to 1:3, and preferably in the range of 1:0.75 to 1:2.5. For bakery products with low water content and less rise, such as cookies, the fiber-to-water weight ratio in the dough can be in the range of 1:0.6 to 1:1.5. For bakery products with high water content and more rise, such as muffins and bread, the fiber-to-water weight ratio in the dough can be in the range of 1:1.3 to 1:2.5. These ranges are given only as examples and not as specific restrictions on usefulness. Actual ratios and ranges which will be determined by the desired characteristics of the baked food.

In one embodiment, the fiber is psyllium fiber. The psyllium fiber can be ground psyllium husk, ground whole psyllium seed, or a mixture thereof. In another embodiment, the fiber is a mixture of coconut fiber and psyllium fiber. In yet another embodiment, the psyllium fiber is a mixture of ground whole psyllium seed and ground psyllium husk, In yet another embodiment, the fiber is a mixture of one or more nut and seed flours, such as almond flour pecan flour, walnut flour, macadamia flour, pistachio flour, sesame seed flour, flax seed flour, and grape seed flour, and one or more gum binders, such as xanthan gum, Guar gum, acacia/arabic gum, locust bean gum, Tragancanth Gum and Talca Gum, and Konjac gum.

Psyllium is produced mainly for its mucilage content. Mucilage is obtained by mechanical milling/grinding of the outer layer of the seed, i.e., the husk, which amounts to about 25% (by weight) of the total seed yield. The psyllium seed mucilage is often referred to as psyllium husk. The milled seed mucilage is a white fibrous hydrophilic material, Upon absorbing water, the clear, colorless, mucilaginous gel that forms increases in volume by tenfold or more. The ground whole psyllium seed, including husk, is an excellent example of a fiber, fat, protein and hydrocolloid mixture. In the preferred embodiment for the disclosed method to partially hydrate in a controlled process the mucilaginous hydrocolloid, milled psyllium seed and psyllium husk has been specifically chosen for it's unique blend of fiber and mucilage. In contrast to the common belief that the whole psyllium seed is rich in starch, the ground whole psyllium seed has a very low starch content with nearly no digestible carbohydrates and is a suitable fiber source for the process of controlled and restricted hydration of a mucilaginous hydrocolloid to create the low-starch dough, mix and baked products of the present invention.

### Protein

The protein component of the dough can be any protein that has nutritional value and provides desired handling properties for the dough, as well as desired taste and texture in the final food product. In certain embodiments, the protein sources are selected based on their effect on water absorption, dough properties such as stickiness, and baking/frying properties. Examples of the protein sources include, but are not limited to, animal proteins, plant proteins, proteins from single cell organisms, free amino acids and mixtures thereof.

Non-limiting examples of useful animal-derived proteins include, but are not limited to, egg proteins isolated or derived from eggs or components of eggs; and mixtures thereof; milk proteins that are isolated or derived from bovine milk or milk derived from other sources; muscle tissue proteins that are isolated or derived from mammals, reptiles or amphibians; and connective tissue proteins. Non-limiting examples of useful milk proteins include caseins, such as sodium caseinate and calcium caseinate; and whey proteins, such as beta-lactoglobulin and alpha-lactalbumin. These milk proteins may be derived from whole milk, skim milk, nonfat dry milk solids, whey, whey protein concentrate, whey protein isolate, caseinates, and mixtures thereof. Non-limiting examples of useful connective tissue proteins include collagen, gelatin, elastin and mixtures thereof.

Non-limiting examples of useful plant derived proteins include: hydrocolloids, seed proteins that are isolated or derived from legumes, such as soybeans, peanuts, peas and beans; cereal proteins isolated or derived from cereal grains, such as wheat, oats, rice, corn, barley and rye; and mixtures thereof.

Additional useful proteins include proteins that are isolated or derived from single cell microorganisms, including but not limited to, yeast, bacteria, algae and mixtures thereof; and free amino acids, in particular essential amino acids that can be added to enhance overall protein quality.

In certain embodiments, the protein source is whole egg or egg white. Fresh whole eggs or egg white are preferred for their water content and their effect on the flavor, richness and color to the food product. In certain embodiments, the naturally existing water from fresh whole egg or egg white provides over 50%, 60%, 70%, 80%, 90% or 95% of total water in the dough. In other embodiments, the naturally existing water from the protein component and fat component (such as butter) of the dough serves as a major wetting agent for the fiber component of the dough. In other embodiments, the naturally existing water from the protein component and fat component provides over 50%, 60%, 70%, 80%, 90% or 95% of total water in the dough. In certain other embodiments, fresh whole egg or egg white, as well as the fat source of the dough, are the sole wetting agents for the fiber component of the dough (i.e., no additional water is added to the dough during the blending process).

### Fat

The fat component of the dough can be any fat that provides desired handling properties in the dough, as well as desired taste and texture in the final food product. As the fat may be used to provide a constrained portion of the water faction for the slow absorption and disbursement to partially wet and inflate the mucilaginous hydrocolloid in a controlled manner, the choice of fat for it's water quantity and other characteristics such as melting point and rate of absorption by the mucilaginous hydrocolloid are a factor in selection of the fat or fat blend component. The fat can be digestible, partially-digestible or non-digestible fat. Fat sources that can be employed in making foodstuffs are well-known to those skilled in the art of baking. The fat source can be in the solid, plastic, semifluid, or liquid form. Examples of fat sources include, but are not limited to, glycerides derived from animal and vegetable, as well as synthetically prepared glycerides. These glycerides can contain saturated or unsaturated “long-chain” acyl radicals having from about 12 to about 22 carbon atoms such as lauroyl, lauroyleoyl, myristoyl, myristoleoyl, palmitoyl, palmitoleoyl, stearoyl, oleoyl, linoleoyl, linolenoyl, arachidoyl, arachidonoyl, behenoyl, erucoyl, and the like and are generally obtained from edible oils and fats such as corn oil, cottonseed oils, soybean oil, coconut oil, rapeseed oil, peanut oil, olive oil, palm oil, palm kernel oil, sunflower seed oil, safflower oil, lard, tallow and the like. These glycerides can also contain, in part, one or two short-chain acyl groups having from 2 to about 6 carbon atoms such as acetyl, propanoyl, valeryl, and caproyl; they can be prepared by random or tow-temperature interesterification reactions of fatty triglyceride containing oils and fats such as interesterified or rearranged cottonseed oil and lard; and they can be otherwise formed by various organic syntheses. Some preferred fat sources are butter, soybean-based shortenings or oils, hydrogenated soybean-based shortening or oil, corn oil, palm oil, hydrogenated palm oil, lard, coconut oil and tallow oils.

Examples of partially-digestible and non-digestible oils and fats include, but are not limited to, polyol fatty acid polyesters, structured triglycerides, plant sterols and sterol esters, other non-digestible lipids such as esterified propoxylated glycerin (EPG), and mixtures thereof. Partially-digestible and non-digestible oils and fats are particularly useful in low-calorie food product.

In one embodiment, the fat source is butter, egg lipids from the whole egg, or a mixture thereof. The naturally existing water in the butter and/or egg lipids also serves as one method to deliver a controlled amount of water at a specific rate of absorption as a wetting agent for the mucilaginous hydrocolloid fiber component of the dough.

### Water

The controlled hydration of the mucilaginous hydrocolloid is the key to the uniform formation of the network of fiber and protein. Using bound water one can partially hydrate mucilaginous hydrocolloid to form sticky connections similar to those formed by starch within traditional baked food. Without wishing to be bound by theory, one possible explanation is that traditional baking principles involve liberal quantities of liquid applied to flour that contains starch, protein and fiber. This aggregate mixture is then mixed until the hydrated starch forms sticky bonds to form the protein and fiber connective tissue that will capture hot gas and solidify into a firm, consumable network in the baked food. If water or other highly absorptive liquid is applied in traditional baking quantities to a mucilaginous hydrocolloid it will be quickly absorbed and bound to form a gel that is unsuitable for the formation of sticky bonds and elastic fibers and proteins to capture hot gases and solidify into a stable baked food network. Abundant and uncontrolled free water in a mucilaginous hydrocolloid will be absorbed and bound and not properly release during the baking process to inflate the baked food. Water availability similar to the quantity, viscosity and availability in traditional starch flour baking will not work to create a stable baking medium with mucilaginous hydrocolloids.

The unique process and method disclosed is the partial wetting through controlled hydration of mucilaginous hydrocolloids. By using very small quantities of free water and water bound in fats and protein that are selectively made available by heat for dispersion and absorption by the mucilaginous hydrocolloid in the baking process, it is possible to regulate the texture, elasticity, rise, spread, crumb structure, rigidity, shear and other factors that determine the end quality of a wide range of traditional baked food products. The water faction is introduced into the dough mixture in limited amounts bound by ingredients such as fat and egg albumin, Free water is used in minimal amounts as compared to traditional starch mucilage dough formation and baking and strictly governed for inclusion during the mixing and dough formation process. The liquids used in the mixing and baking process are small amounts of free water and bound water such as in butter and egg protein albumin used only to the extent of partially wetting the mucilaginous hydrocolloid to form specific structural characteristics but not to the extent that the mucilage is fully hydrated to the gel stage. This is very specific to this unique process for using mucilaginous hydrocolloids to form baked foods since mucilaginous hydrocolloids are approximately ten-times more absorptive of free water than starch based flour mixtures. This bound water and free water is only partially absorbed slowly into the mucilaginous hydrocolloid during the mixing and dough making phases. The bound water converts to free water during the baking process to be absorbed and tightly bond by the mucilaginous hydrocolloid to form sticky bonds similar in function to starch bonds used in traditional baking to connect the protein and fiber network. During the mixing process the fat and egg albumin protein allow the dough to mix and become pliable but the water faction is bound in these ingredients and only limited free water is available to be absorbed by the highly absorptive mucilaginous hydrocolloid. The highly absorptive mucilaginous hydrocolloid is also partially impeded in its absorption by the fat and egg albumin protein. During the baking process the water is converted from bound water to free water by heat. Some of the now released free water is then partially absorbed by the mucilaginous hydrocolloid which then binds the limited available water to form sticky bonds. The partially gelled mucilaginous hydrocolloid fibers and proteins become more elastic due to partial hydration. The remainder of the now available free water is converted to hot gases to form gas pockets to inflate the network. The stickiness of the partially wetted mucilaginous hydrocolloid binds and anchors the long chain carbohydrate fiber strings and protein strings to form the network to capture the now available steam gases released during the baking process. At no time is starch or starch mucilage necessary to bind or complete the formation of the network within the baked food, which is a complete departure from current assumptions that require starch bonds for all traditional baked food networks. As only a limited supply of water is available and quickly disbursed when heated into hot gases or absorbed by the mucilaginous hydrocolloid to form the sticky network of fibers the process ends when the liquid is expended and when properly controlled using this unique process the mucilaginous hydrocolloid never converts to a gelatinous state. The final network of partially hydrated carbohydrate fiber and protein strands then cools and solidifies to support the structure of the baked food. The moistness and texture, bite and other common organoleptic characteristics are partially controlled by the amount of liquid that remains entrained in the mucilaginous hydrocolloid fibers in the final product. If the mucilaginous hydrocolloid network of the final baked product contains too much bound water the final product may have a spongy feel during mastication or the network structure may collapse having converted to far to the gel stage to support the weight of the baked food. Other ingredients with bound water can also be utilized during the mixing and dough formation process. Small quantities of free water as well as carefully incorporated wet ingredients such as low water content fruit and even very limited amounts of free water in flavor agents can be added either during the dough formation or as a final mix stage just prior to baking with various effects on the organoleptic characteristics of the final baked food product.

### Other Additives

Additives are necessary for processing and structural development of most foods. Additives are also used to add flavor, aroma, and color to food products. Examples of typical food additives include processing aids, emulsifiers, and leavening agents, flavoring agents, sweeteners, bracers, natural and synthetically prepared colors, preservatives, and acidulants.

Leavening agents are used to provide the internal expansion or rise of the product during baking. Processing aids such as reductants and enzymes are required either singularly or in combination to allow adequate machining (i.e., dough sheeting and die cutting), and/or development of necessary structure. The role of the emulsifier is to aid in processing (for example sheeting dough) and the formation of the internal product structure.

Selection of the appropriate type and level of additives is easily determined by one skilled in the art. For example, it is known that cookies rely heavily on the use of leavening agents and emulsifiers. Other baked goods such as brownies, muffins, snack cakes, and pastries also rely on leavening agents and emulsifiers to achieve their desired structure. Snack cakes are at the high end of functionality, as they require the most care in the choice and blends of leavening agents and emulsifiers to achieve their tender highly cellular structure. Brownies are generally at the lower end of functionality, as they typically have a more dense structure.

A flavoring agent is often used to further enhance the taste of the foodstuff. As used herein the term “flavoring agent” encompasses any seasonings and spices. In certain embodiments, the flavoring agent is a low-calorie or no-calorie flavoring agent. A flavoring agent containing calorie in the amount equal to, or less than, about 1 calorie per gram of the flavoring agent is considered a “low-calorie” flavoring agent. Flavors may be added to the initial formulation, or be added topically after the product is produced. When used in any embodiment, flavoring agents are added in effective levels. Other flavoring ingredients may include but not limited to ingredients mixed into the dough to be suspended in the final product such as low calorie and sugar free chocolate chips, fresh and dry fruit, coconut flakes, nuts and other component amendments that are deemed appropriate to enhance taste or for purposes of variety. The final product may also be enrobed in various other food substances such as but not limited to a low calorie or sugar free melted chocolate coating, candy sprinkles, spices and flavor ingredients applied to the baked surface such as cinnamon, cheese, oregano, dried vegetables, fruit or cream jellies that may be applied or injected as a filler. The final product may also be used in conjunction with other kinds of foods such as but not limited to make sandwich cookies where a cream filling is sandwiched between two halves of the product that has been formed into a cookie shape or used to sandwich low calorie or sugar free or no sugar added ice cream and other confections that involve a baked food product in conjunction with other food components to form a final product.

Effective levels of sweetener can be used in all embodiments of the present invention to further sweeten said embodiments. In certain embodiments, the sweetener is a low-calorie or no-calorie sweetener agent. A sweetener containing calorie in the amount equal to, or less than, about 1 calorie per gram of the flavoring agent is considered a “low-calorie” sweetener agent. Examples of no-caloric sweeteners include erythritol and Rebaudioside, ACE-K, Splenda etc. Sweetening agent such as erythritol may also acts as a bulking agent and makes it much easier to make dough. Erythritol also effects mouth feel by adding glaciation to the bite. In one embodiment, the low-starch, high fiber dough contains erythritol in the amount of 10-60% by weight.

Bracers may be used in a safe and effective quantity to achieve mental refreshment and alertness. The methylxanthines, caffeine, theobromine and theophylline, are well known examples of bracers. Numerous other xanthine derivatives have been isolated or synthesized. For example, Bruns, Biochem. Pharmacol., 30, 325-333, (1981), describing more than one hundred purine bases and structurally related heterocycles relative to xanthine. One or more of these compounds are present in the coffee bean, tea, kola nut, cacao pod, mate, yaupon, guarana paste and yoco. Natural plant extracts are the preferred sources of bracers as they may contain other compounds that delay the bioavailability of the bracer; thus they may provide mental refreshment and alertness without jitters. The most preferred methylxanthine is caffeine. Preferred botanical sources of caffeine that may be used as a complete or partial source of caffeine include green tea, guarana, mate, black tea, cola nuts, cocoa and coffee. Green tea, guarana and mate are the most preferred botanical sources of caffeine. Guarana functions in a manner similar to green tea. Thus, guarana may be used to decrease the bioavailability of caffeine, thereby reducing or eliminating the caffeine jitters.

Embodiments of the present invention may optionally be fortified with vitamins and minerals. Examples of vitamins include vitamins A, D, E, K, C (ascorbic acid), thiamin, riboflavin, niacin, vitamin B6, folate, vitamin B12, biotin, and pantothenic acid. These vitamin sources are preferably present in nutritionally relevant amounts, which means that the vitamin sources used in the practice of this invention provide a nourishing amount of said vitamins. Preferably, this amount comprises at least about 1% of the U.S. RDA or RDI for said vitamin, more preferably from about 1% to about 100%, and most preferably from about 10% to about 100% of the U.S. RDA or RDI per 30 g reference serving of the finished product.

Examples of minerals include, but are not limited to, calcium, phosphorus, magnesium, iron, zinc, iodine, selenium, copper, manganese, fluoride, chromium, molybdenum, sodium, potassium, and chloride. The minerals sources are preferably present in nutritionally relevant amounts, which means that the mineral sources used in the practice of this invention provide a nourishing amount of said minerals. Preferably, this amount comprises at least about 1% of the U.S. RDA or RDI for these minerals, more preferably from about 1% to about 100%, and most preferably from about 10% to about 100% of the U.S. RDA or RDI per 30 g reference serving of the finished product.

The source of the mineral salt, both those with established U.S. RDA levels or with safe and adequate intake levels, as well as those with no as yet established human requirement, used in the practice of this invention, can be any of the well known salts including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals. The particular salt used and the level will depend upon their interaction with other food product ingredients. Elemental iron (electrolytic or reduced iron) is another preferred source of iron.

Coloring agents can also be added to the food compositions of the present invention. Any soluble coloring agents approved for food use can be utilized for the present invention.

When desired, preservatives, such as sorbic acid, benzoic acid, hexametaphosphate and salts thereof; acidulants such as citric acid, malic acid, fumaric acid, adipic acid, phosphoric acid, gluconic acid, tartaric acid, ascorbic acid and mixtures thereof, can be added into embodiments of the present invention.

In another embodiment, the disclosed process to use partial hydration of certain mucilaginous hydrocolloids to form no starch and low-starch, high-fiber food products is a baked food product. The resulting baked food product contains 3-30% protein by weight, 10-40% fiber by weight, 10-40% fat by weight, at least one additive in the amount of 1-50% by weight, and 2-10% water by weight The fiber and protein components provide bulk to support a structure of the baked food product without the need for starch bonds. The sticky bonds of the partially hydrated mucilaginous hydrocolloid connect the protein and fiber strands to capture hot expanding gas in the baking process and then form the self-supporting bread-like network common to baked foods, which has a digestible starch content of 15% or less by weight and a digestible carbohydrate content of 17% or less by weight. In one embodiment, the food product has a digestible starch content of 10% or less by weight and a digestible carbohydrate content of 12% or less by weight. In another embodiment, the food product has a digestible starch content of 5% or less by weight and a digestible carbohydrate content of 7% or less by weight. In another embodiment, the food product has a digestible starch content of 2% or less by weight and a digestible carbohydrate content of 4% or less by weight. In another embodiment, the food product has a digestible starch content of 1% or less by weight and a digestible carbohydrate content of 2% or less by weight. In another embodiment, the fiber is psyllium fiber. In another embodiment, the fiber is a mixture of coconut fiber and psyllium fiber. In yet another embodiment, the psyllium fiber is a mixture of ground whole psyllium seed and ground psyllium husk, and the additive is erythritol or Rebaudioside A.

In another embodiment, the disclosed process to use partial hydration of certain mucilaginous hydrocolloids to form no starch and low-starch, high-fiber food product is a baking mix. The baking mix contains 5-30% protein by weight, 10-40% fiber by weight, 1-20% fat by weight, and at least one additive in the amount of 1-50% by weight, The baking mix has a digestible starch content of 15% or less by weight and a digestible carbohydrate content of 17% or less by weight. In one embodiment, the baking mix has a digestible starch content of 10% or less by weight and a digestible carbohydrate content of 12% or less by weight. In another embodiment, the baking mix has a digestible starch content of 5% or less by weight and a digestible carbohydrate content of 7% or less by weight. In another embodiment, the baking mix has a digestible starch content of 2% or less by weight and a digestible carbohydrate content of 4% or less by weight. In another embodiment, the baking mix has a digestible starch content of 1% or less by weight and a digestible carbohydrate content of 2% or less by weight. In another embodiment, the fiber is psyllium fiber, In another embodiment, the fiber is a mixture of coconut fiber and psyllium fiber. In yet another embodiment, the psyllium fiber is a mixture of ground whole psyllium seed and ground psyllium husk, and the additive is erythritol or Rebaudioside A.

Also disclosed is a method for making low-starch, high-fiber dough. The method includes: combining a fiber with a protein component, a fat component, and at least one additive, and blending the combined materials into a dough with a uniform texture, wherein the naturally existing water in the fat component and the protein component serve as the major wetting agent for the fiber. In one embodiment, the fiber is psyllium fiber and the protein component comprises freshly prepared whole eggs or egg white. The term “freshly prepared whole eggs or egg white” refers to whole eggs or egg white that have not been frozen, dried, or lyophilized.

Also disclosed is a method for using psyllium fiber as a low-starch nutritional supplement for patients in need of controlling carbohydrate intake. The method includes: mixing psyllium fiber with a low-starch fat component, a low-starch protein component and at least one low-starch food additive to form a dough; and baking the dough to produce a bakery product, wherein the bakery product has a digestible starch content of 5% or less by weight and a digestible carbohydrate content of 7% or less by weight.

### EXAMPLES

### Example 1

### Experiments on Basic Baking Mix

A number of experiments were conducted to determine the optimal amount of fiber, fat and protein in a low-starch, high fiber baking mix. The compositions of the test mixes and the test results are summarized in Tables 1-18. Briefly, the dry components of the baking mix were combined to form a dry mix. The dry mix was then added to the liquid component(s) of the baking mix and thoroughly blended to form dough. The dough was shaped into dough balls or loafs, and baked under various baking conditions to form the final baking product.

The amount of water in the baking mix is critical to the final product. Cohesion of the dough and rise of the loaf is a function of the amount of water in the mix. The experiments revealed that the water contained in the fat component (e.g., butter) and protein component (e.g., egg white) is sufficient to serve as the wetting agent for the fiber to give the dough desired workability and “wetness” and allow sufficient rise of the loaf. The exact amount of water needed to achieve partial hydration of the soluble fiber varies with the type of fiber and the composition of the baking mix. Good results had been obtained using dough having a fiber-to-water (including bound and free water) ratio (w/w) in the range of 1:0.75 to 1:2.4.

The amount and type of liquid components used in preparing the dough is also determined by the intended final food product. For example a bread or muffin may require more liquid than a pizza crust or a cracker which is much dryer and needs far less air pockets. A brownie that is very dense and thick may require even more liquid. The type of liquid is also a factor as egg albumin contributes to constraining the product to form a “tight” round shaped cookie where more fat in the mix will cause more spread and puffiness from the steam. Egg yolk may contribute a denser product and any combination of these and other liquids will have varying effects on the final outcome in conjunction with adjustments to the dry portion. It was found that psyllium is a very active hydrocolloid and that large amounts of oil and protein are required to keep the psyllium separated in the blend so that dough can be formed.

Without wishing to be bound by theory, one possible explanation for the results obtained in these experiments is that a low water environment allows for the partial hydration of strong hydrocolloids, such as psyllium fiber and the formation of a gluten-like reticular net and binding characteristics similar in function to starch mucilage bonds within the dough, analogous to the function of gluten and starch in conventional baking. This partial hydration also results in a high fiber food product that is much more edible than the other food products with similar fiber content (i.e., 30-40% fiber). In the stomach, when combined with more water, either from digestive fluids or liquids consumed in the course of the meal, the hydrocolloid (e.g., psyllium husk) acts to coat and separate the indigestible fiber fraction allowing comfortable digestion and intestinal motility of a high fiber product

It should be noted that psyllium husk or high psyllium husk formulations can have an undesirable taste and off gassing that is difficult to mask or reduce. It was found that, as the psyllium seed and husk levels were lowered, the texture and the taste of the loaf improved. On the other hand, a substantial whole seed psyllium fraction that typically contains 75% kernel and 25% husk can, with the proper flavorings, be made into a saleable product.

The addition of whey and/or erythritol and or inulin improves the overall texture and consistency of the finished baked product. While whey protein isolate is used in certain embodiments, because it is free of fat, lactose sugar and gluten, other dough conditioners, protein amendments and inert carbohydrate fillers that can be used in varying quantities to change the organoleptic properties and other characteristics of the final food product. In certain embodiments, whey protein is used in the amount of 10-30% of the weight of the food product. The amount may be adjusted based on the nature of the amendment, desired finished product characteristics and overall composition. It appears that a sufficient amount of protein or inert carbohydrate fillers may contribute to a better product.

Experiment 15, 16 and 17 in Attachment 1 are tests of psyllium husk only. All of the experiments were conducted with butter creamed into the egg-white portion prior to adding the dry portion to increase the air content of the final product. The air cell structure of these loaves does expand with good rise and balloon with air pockets very similar to a normal wheat bread particularly in Experiment 17, which has the least liquid.

Experiment 18 demonstrates how critical the amount of water is to the final product. It appears that the psyllium seed expanded to form a “dry crumb” structure. Instead of forming large porous air holes throughout, the crumb structure is dense and the individual crumbs appear to be fluffed by the water instead of the steam expanding the mucilage into an open cell matrix of air pockets. In addition, the final product failed to properly rise or spread and appears constricted. The final product of Experiment 18, however, formed into a very crisp and dry bread structure similar in texture to a crouton or biscotti. There are possible applications for various products such as crusts, crackers, biscotti, etc. when the minor remaining psyllium taste is disguised.

In contrast, the dough in Experiment 17, which was made entirely with psyllium husk instead of whole psyllium seed and contained less liquid than the dough in Experiment 18, yielded the best final baked results. The loaf is well formed with good, round top and rise and spread. In addition the undesirable psyllium taste is dramatically reduced. This result suggests that the source of psyllium fiber, be it psyllium husk, ground whole psyllium seed, or mixtures thereof, may play an important role in the taste and texture of the final baked product. The amount of liquid combined with the psyllium mucilage may significantly contribute to the unfavorable off gassing smells associated with using only psyllium husk.

TABLE 3
BASIC COOKIE
DATE: May 6, 2009

| | | | BOUND WATER | BOUND WATER | TOTAL |
|---|---|---|---|---|---|
| INGREDIENTS | PERCENT | LAB | PERCENT | WEIGHT | STARCH |
| ERYTHITOL | 0.00% | 0.00 | | | 0 |
| PSYLLIUM POWDER | 65.00% | 147.55 | | | 1.48 |
| WHEY PROTIEN | 21.39% | 48.56 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| FLAVOR | 0.00% | 0.00 | | | 0 |
| DRY INGREDIENT TOTAL | 100.00% | 227.00 | <1 | <1 | 1.48 grams |
| EGG WHITE | | 227.00 | 88.00% | 200 grams | |
| BUTTER | | 113.50 | 17.00% | 19.3 grams | |
| BOUND WATER TOTAL | 100.00% | 219.30 | | | |
| TOTAL DRY AND BOUND WATER | 100.00% | 446.30 | 49.00% | | |

375 degrees for 20 minutes
Same Comp as Exp. 2 but creamed Egg & Butter
More air pockets in final product. Lighter weight.
Still no rise and top center still partially unbaked
Still very dense.

TABLE 4
BASIC COOKIE
May 6, 2009

| | | | BOUND WATER | BOUND WATER | TOTAL |
|---|---|---|---|---|---|
| INGREDIENTS | PERCENT | LAB | PERCENT | WEIGHT | STARCH |
| ERYTHITOL | 0.00% | 0.00 | | | 0 |
| PSYLLIUM POWDER | 65.00% | 147.55 | | | 1.48 |
| WHEY PROTIEN | 21.39% | 48.56 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| FLAVOR | 0.00% | 0.00 | | | 0 |
| DRY INGREDIENT TOTAL | 100.00% | 227.00 | <1 | <1 | 1.48 grams |
| EGG WHITE | | 227.00 | 88.00% | 200 grams | |
| (thick and thin albumin) | | | | | |
| BUTTER | | 113.50 | 17.00% | 19.3 grams | |
| BOUND WATER TOTAL | 100.00% | 219.30 | | | |
| TOTAL DRY AND BOUND WATER | 100.00% | 446.30 | 49.00% | | |

375 degrees for 20 minutes
Same comp. as Exp. 2. Mix ingedients only
Allow dough to sit for 10-12 minutes
Still no rise. Still dense.
Top center still not completely baked

TABLE 5
BASIC COOKIE
May 6, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM POWDER | 65.00% | 147.55 | | | 1.48 |
| WHEY PROTIEN | 21.39% | 48.56 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| FLAVOR | 0.00% | 0.00 | | | 0 |
| DRY INGREDIENT TOTAL | 100.00% | 227.00 | | | 1.48 grams |
| EGG WHITE | | 170.00 | 88.00% | 150 grams | |
| (thick and thin albumin) | | | | | |
| BUTTER | | 170.00 | 17.00% | 29 grams | |
| BOUND WATER TOTAL | 100.00% | 179.00 | | | |
| TOTAL DRY AND BOUND WATER | 100.00% | 406.00 | 44.00% | | |

350 degrees for 30 minutes
Same composition as Exp 2
decrease Egg white to 170 g
Increase butter to 170 g
decrease heat to 350 degrees
Extend bake time to 30 minutes
Final product very corn bread like texture.
Almost no rise in loaf
Biscuts show rounding, some rise and top cracks
Overall better composition
Slightest bit of unbaked at top center.
By increasing the amount of water bound in thick fat faction and decreasing free water of thinner egg albumin faction the composition improved. Also decreasing overall water content improved the composition.

TABLE 6
BASIC COOKIE
May 6, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM POWDER | 60.00% | 136.20 | | | 1.36 |
| WHEY PROTIEN | 16.39% | 37.21 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| PSYLLIUM HUSK | 10.00% | 22.70 | | | 0 |
| FLAVOR | 0.00% | 0.00 | | | |
| DRY INGREDIENT TOTAL | 100.00% | 227.00 | <1 | <1 | 1.36 grams |
| EGG WHITE | | 170.00 | 88.00% | 150 grams | |
| (thick and thin albumin) | | | | | |
| BUTTER | | 170.00 | 17.00% | 29 grams | |
| BOUND WATER TOTAL | 100.00% | 179.00 | | | |
| TOTAL DRY AND BOUND WATER | 100.00% | 406.00 | 44.00% | | |

350 degrees for 30 minutes
Same composition as Exp 5
Add 10% psyllium husk
Reduce psyllium seed and whey 5% each
350 degrees
30 minutes
Final product poorer texture
outter area under crust has unbaked look
More unbaked look at top center of loaf
Realize unbaked section is congealed mucilage
Adding more husk increased excess mucilage

TABLE 7
BASIC COOKIE
May 6, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 55.00% | 124.85 | | | 1.25 | |
| WHEY PROTIEN | 31.39% | 71.26 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.25 | grams |
| EGG WHITE (thick and thin albumin) | | 170.00 | 88.00% | 150 grams | | |
| BUTTER | | 170.00 | 17.00% | 29 grams | | |
| BOUND WATER TOTAL | 100.00% | 179.00 | | | | |
| TOTAL DRY AND BOUND WATER | 100.00% | 406.00 | 44.00% | | | |

350 degrees for 30 minutes
Same composition as Exp 5
Decrease Psyllium Seed by 10%
Increase Whey 10%

TABLE 8
BASIC BAKED FOODS
May 6, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 45.00% | 102.15 | | | 1.02 | |
| WHEY PROTIEN | 41.39% | 93.96 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.02 | grams |
| EGG WHITE (thick and thin albumin) | | 170.00 | 88.00% | 150 grams | | |
| BUTTER | | 170.00 | 17.00% | 29 grams | | |
| BOUND WATER TOTAL | 100.00% | 179.00 | | | | |
| TOTAL DRY AND BOUND WATER | 100.00% | 406.00 | 44.00% | | | |

350 degrees for 30 minutes
Same composition as Exp. 7
Decrease Psyllium Seed by 10%
Increase Whey 10%
GOOD DINNER ROLL and CRACKER
muffin pan constrained is well formed.
muffin round on top brittle crust sponge Interior
Bisquit unconstrained spread into hard cracker
loaf flat on top but inproved texture and crust

TABLE 9
BASIC BAKED FOOD
May 6, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 45.00% | 102.15 | | | 1.02 | |
| WHEY PROTIEN | 41.39% | 93.96 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.02 | grams |
| EGG WHITE (thick and thin albumin) | | 227.00 | 88.00% | 200 grams | | |
| BUTTER | | 170.00 | 17.00% | 29 grams | | |
| BOUND WATER TOTAL | 100.00% | 229.00 | | | | |
| TOTAL DRY AND BOUND WATER | 100.00% | 456.00 | 50.00% | | | |

350 degrees for 30 minutes
Same composition as Exp. 8
Increase Egg white
GOOD DINNER ROLL
texture is more tight porous than Exp. 8
muffin pan constrained is well formed.
Crust not as brittle as Exp. 8
Bisquit spread but maintained more soft sponge
Loaf a little more round but still mostly flat

TABLE 10
BASIC BAKED FOOD
May 6, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 45.00% | 102.15 | | | 1.02 | |
| WHEY PROTIEN | 41.39% | 93.96 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.02 | grams |
| EGG WHITE (thick and thin albumin) | | 170.00 | 88.00% | 150 grams | | |
| BUTTER | | 227.00 | 17.00% | 39 grams | | |
| BOUND WATER TOTAL | 100.00% | 189.00 | | | | |
| TOTAL DRY AND BOUND WATER | 100.00% | 416.00 | 45.00% | | | |

350 degrees for 30 minutes
Same composition as Exp. 8
Increase butter
BETTER OVERALL RESULTS THAN EXP. 9
GOOD MUFFIN, COOKIE, LOAF
nice cookie shape for possible butter cookie muffin pan constrained is well formed.
Crust not as brittle as Exp. 8
Biscut spread but maintained more soft sponge
Loaf a little more round but still mostly flat
As the amount of bound water in the fat faction is increased the quality of the baked food product improves. It appears that the amount of fat and bound water in the thick fat liquid faction needed to be increased and the amount of egg albumin and the more loosely bound water it contains in a thinner liquid faction may have needed to decrease to not over wet the mucilage. One can predict that the thickness of the liquid faction as well as the amount of water bound up in the thick liquid faction as well as the temperature or other factors such as dough conditioners that interact with the controlled conversion of the bound water in the thick liquid faction to free water are all factors in contributing to varying degrees on the characteristics of the final baked food when working with bound water to partially wet mucilagenous hydrocolloids to a functional state for baking and not to the gelatenous stage. It appears that too much bound water in a liquid faction such as egg albumin that is more easily converted to free water than in the fat faction will have the same adverse effects as simply adding loose water which is to quickly convert the mucilage to gel instead of making it elastic and sticky to form the baked food network. A specific and strictly controlled release of water converted from bound to free water using liquids of varying thickness and with varying bound water content appers to be the key to the partial controlled hydration of mucilagenous hydrocolloids to form baked food fiber networks free of starch

TABLE 11
BASIC BAKED FOOD
May 6, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 45.00% | 102.15 | | | 1.02 | |
| WHEY PROTIEN | 41.39% | 93.96 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.02 | grams |
| EGG WHITE | | 227.00 | 88.00% | 200 grams | | |
| BUTTER | | 227.00 | 17.00% | 39 grams | | |
| BOUND WATER TOTAL | 100.00% | 239.00 | | | | |
| TOTAL DRY AND BOUND WATER | 100.00% | 466.00 | 51.00% | | | |

350 degrees for 30 minutes
Same composition as Exp. 8
increase egg white and Butter
BEST OVERALL
NICE MUFFIN
NICE LOAF WITH ROUNDNESS ON TOP
BAKED THROUGH
WHOLE WHEAT TEXTURE
DENSE BUT POROUS WITH CRUST
FLAVOR NOT TOO INTENSE
The proportion of these particular thick liquids at approximately 50% appears to create a bread-like character. Exp. 8 with 44% bound water in the same proportion produced a dryer final product. The increased amount of bound water added with the increase in egg albumin translated to the overall softening of the mucilage so that it appears that the specific amount of bound water that is converted to free water effects the overall end product characteristics. Of note, as anticipated the amount of mucilage to be hydrated is also a factor as in Exp. 1 where 66% bound liquid with the greater percentage from the egg albumin produced a dense and oily final product as it over saturated the amount of mucilage in the blend. For this amount of mucilage and these specific thick liquids, egg albumin and butter this 51% delivers a bread-like characteristic. Were one to want a dryer tighter characteristic such as in Exp. 8 for a dinner roll or flat bread or cracker final product the overall liquid factions and bound water would be reduced for that particular amount of mucilage in that particular blend of ingredients. The concept of controlled partial hyrdation of mucilagenous hydrocolloids works for stable final baked foods free of starch but the blends will need to vary to meet the needs and characteristics of the desired final baked product.

TABLE 12
BASIC BAKED FOOD
May 7, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 55.00% | 124.85 | | | 1.25 | |
| WHEY PROTIEN | 31.39% | 71.26 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| FLAVOR | 0.00% | 0.00 | | | 0 | |
| DRY INGREDIENT TOTAL | 100.00% | 227.00 | <1 | <1 | 1.25 | grams |
| EGG WHITE (thick and thin albumin) | | 227.00 | 88.00% | 200 grams | | |
| BUTTER | | 227.00 | 17.00% | 39 grams | | |
| BOUND WATER TOTAL | 100.00% | 239.00 | | | | |
| TOTAL DRY AND BOUND WATER | 100.00% | 466.00 | 51.00% | | | |

350 degrees for 30 minutes
Same composition as Exp 7
Increase Egg White and Butter
Better crumb structure than Exp. 11
Not as tight a porous structure
More Psyllium seed off taste
A little too oily to the touch
Keeping the bound water ingredents the same as Exp. 11 which produced a bread-like finished baked food but changing the proportion of psyllium caused the final baked food to have a looser crumb structure and network but the taste of the psyllium was stronger and it was more oily suggesting that the increase in mucilage changed the amount and degree of absorption of free water released from the fat and protein liquids. This suggests that the amound of mucilage is an independent factor dependent on the amount hydration from the bound water but another variable.

TABLE 13
BASIC BAKED FOOD
May 7, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| PSYLLIUM POWDER | 45.00% | 102.15 | | | 1.02 | |
| WHEY PROTIEN | 34.00% | 77.18 | | | 0 | |
| CREAM OF TARTAR | 7.00% | 15.89 | | | 0 | |
| BAKING SODA | 7.00% | 15.89 | | | 0 | |
| SALT | 3.00% | 6.81 | | | 0 | |
| STEVIA | 0.00% | 0.00 | | | 0 | |
| CELLULOSE HP-8A | 4.00% | 9.08 | | | 0 | |
| FLAVOR | 0.00% | 0.00 | | | 0 | |
| TOTALS | 100.00% | 227.00 | <1 | <1 | 1.02 | grams |
| EGG WHITE | | 227.00 | 88.00% | 200 grams | | |
| BUTTER | | 198.00 | 17.00% | 34 grams | | |
| BOUND WATER TOTAL | 100.00% | 234.00 | | | | |
| TOTAL DRY AND BOUND WATER | 100.00% | 461.00 | 50.00% | | | |

350 degrees for 30 minutes
Composition slightly shifted overall
Butter reduced from Exp. 12 by 2 TBL
Psyllium reduced for flavor
leavening and cellulose slightly increased
Whey more than Exp. 12 and less than Exp. 11
Muffin looks good and texture good
Loaf sunk down in middle but nice texture inside
cookie looks good but not a bisquit
Still oily feel and the off taste and smell worse
It appears that even small changes to the whey protein can also effect the rate and degree to which the mucilage is able to absorb the free water released from the bound water in the butter and egg albumin and effect the character of the final product. Dough conditioners such as the whey protein and inulin appear to effect the rate and degree of hydration of the mucilagenous hydrocolloid to effect different characteristics in the final baked food.

TABLE 14
BASIC BAKED FOODS
May 7, 2009

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 0.00% | 0.00 | | | 0 | |
| Coconut Flour | 30.00% | 68.10 | | | 18 | grams |
| WHEY PROTIEN | 41.39% | 93.96 | | | 0 | |
| CREAM OF TARTAR | 4.70% | 10.67 | | | 0 | |
| BAKING SODA | 4.70% | 10.67 | | | 0 | |
| SALT | 2.53% | 5.74 | | | 0 | |
| STEVIA | 0.00% | 0.00 | | | 0 | |
| CELLULOSE HP-8A | 1.68% | 3.81 | | | 0 | |
| PSYLLIUM HUSK | 15.00% | 34.05 | | | 0 | |
| DRY INGREDIENT TOTAL | 100.00% | 227.00 | <1 | <1 | 18 | grams |
| EGG WHITE (thick and thin albumin) | | 227.00 | 88.00% | 200 grams | | |
| BUTTER | | 227.00 | 17.00% | 39 grams | | |
| BOUND WATER TOTAL | 100.00% | 239.00 | | | | |
| TOTAL DRY AND BOUND WATER | 100.00% | 466.00 | 51.00% | | | |

350 degrees for 30 minutes
Same composition as Exp. 8
COCONUT AND HUSK
Replace Psyllium Seed with Coconut and husk
Rise similar to psyllium seed husk
nice flakey porous composition
mild coconut flavor
Loaf top still has slight fall and no roundness
formed crust and interior sponge
It appears possible to use other forms of gluten free flour with psyllium husk and still form elastic networks from the partial wetting of the mucilagenous hydrocolloid but the disadvantage of such hybrid baked goods is that they are far higher in digestible carbohydrates and will have a much bigger impact on blood glucose and Candida based health conditions. For purposes of variety and taste it is possible to use the psyllium husk which is approximately 99% mucilage with an alternative flour to replace the milled psyllium kernel flour and still obtain a crumb structure with some fiber network. One can probably develop viable blends of psyllium husk with other alternative flour such as coconut that is lower in digestible carbohydrates but there appears to be no improvement in the fiber network and the disadvantage of using alternative flours with higher amounts of starch is adding more carbohydrates that will digest to glucose.

TABLE 15
BASIC BAKED FOOD
May 12, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM SEED | | 0.00 | | | 0 |
| WHEY PROTIEN | 48.18% | 109.37 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| PSYLLIUM HUSK | 38.21% | 86.74 | | | 0 |
| DRY INGREDIENT TOTAL | 100.00% | 227.00 | <1 | <1 | 0 |
| EGG WHITE (thick and thin albumin) | | 227.00 | 88.00% | 200 grams | |
| BUTTER | | 227.00 | 17.00% | 39 grams | |
| BOUND WATER TOTAL | 100.00% | 239.00 | | | |
| TOTAL DRY AND BOUND WATER | 100.00% | 466.00 | 51.00% | | |

350 degrees for 30 minutes
REMOVE ALL PSYLLIUM SEED POWDER
REPLACE SEED WITH PSYLLIUM HUSK
DETERMINE HUSK PORTION BASED ON
EARLIER ORIGINAL EXPERIMENTS AND BEST
RESULTS WITH HUSK
ADJUST WHEY PORTION TO ALLOW
FOR DIMINISHED BULK OF HUSK VS SEED
USE BEST RESULTS FOR LIQUID PORTION
BASED ON EXPERIMENTS WITH SEED PWDR
LIQUID INGRED. CREAMED AND DRY ADDED
LOAF AND MUFFIN MUCH MORE RISE
MORE SPONGE LIKE WITH LARGER MORE
POROUS GAS MATRIX INSIDE THE LOAF
AND MUFFIN. NICE OUTSIDE CRUST
NOTICE MOISTURE ON HANDS SO SUSPECT
LIQUID TOO HIGH. ALSO MIDDLE OF LOAF
STILL COLLAPSED. NO SIGN OF
UNINCORPORATED MUCILAGE IN FINAL
BAKED PRODUCT
This experiment proves that it is possible to make a stable baked food entirely from the psyllium husk which is considered to be 99% mucilage. A stable internal fiber network of elastic fibers was created using bound water in the fat and egg albumin that partially hydrated the mucilage and formed elastic fibers and sticky bond anchors without any starch in the blend. This proves that using controlled partial hydration of the mucilage one can entirely replace starch and gluten in baked foods and still form a gas encapsulating network made entirely of fiber, protein and fat without the need for starch or gluten. Using controlled hydration through bound water in fat and protein it is possible to control the hydrophilic properties of the mucilage and control the absorption and binding water as well as control the degree of hydration to obtain stable results for baking purposes.

TABLE 16
BASIC BAKED FOOD
May 16, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM SEED | | 0.00 | | | 0 |
| WHEY PROTIEN | 48.18% | 109.37 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| PSYLLIUM HUSK | 38.21% | 86.74 | | | 0 |
| DRY INGREDIENT TOTAL | 100.00% | 227.00 | <1 | <1 | 0 |
| EGG WHITE (thick and thin albumin) | | 112.00 | 88.00% | 99 grams | |
| BUTTER | | 227.00 | 17.00% | 39 grams | |
| BOUND WATER TOTAL | 100.00% | 138.00 | | | |
| TOTAL DRY AND BOUND WATER | 100.00% | 365.00 | 38.00% | | |

350 degrees for 30 minutes
SAME DRY INGRED. AS EXP. 15
DECREASE EGG WHITE TO 112 G
LIQUID INGRED. CREAMED
LIQUIDS DO NOT COMPLETELY COMBINE
BETTER RESULTS
GOOD RISE IN LOAF AND MUFFIN
LOAF STILL SLIGHT SAG IN TOP
DRYER CRUST AND OVERALL TEXTURE
FREE STANDING BISQUIT MORE ROUND
MUFFIN IN MUFFIN PAN FLAT ON TOP
NICE OUTSIDE BROWN COLOR
POROUS INSIDE WITH NICE FORMED GAS
HOLES IN MATRIX
MUCH DRYER OVERALL PRODUCT
As the psyllium seed mixture of husk and kernal has a much lower amount of mucilage than the husk which is 99% mucilage the hydrophilic characteristics are far greater in this mixture using entirely husk so that it can be anticipated that it will take less bound water converting to free water and partially hydrate the mucilage to form sticky fiber strands to form the network to encapsulate hot gases in the baking process. By reducing the thick semi-liquid fat and albumin portions it appears that we are reducing the amount of free water the fibers can absorb and bind in the baking process and reducing the degree to which they begin to convert to gel so that they can only partially convert to gel and instead form elastic fibers and sticky bonds to anchor the protein and fiber network. Finding the best combination of bound water ingredients and hydrophilic fiber is critical to the characteristics of the final product.

TABLE 17
BASIC BAKED FOOD
May 13, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM SEED | | 0.00 | | | 0 |
| WHEY PROTIEN | 48.18% | 109.37 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | 1.68% | 3.81 | | | 0 |
| PSYLLIUM HUSK | 38.21% | 86.74 | | | 0 |
| DRY INGREDIENT TOTAL | 100.00% | 227.00 | <1 | <1 | 0 |
| EGG WHITE (thick and thin albumin) | | 112.00 | 88.00% | 99 grams | |
| BUTTER | | 112.00 | 17.00% | 19 grams | |
| BOUND WATER TOTAL | 100.00% | 118.00 | | | |
| TOTAL DRY AND BOUND WATER | 100.00% | 345.00 | 34.00% | | |

350 degrees for 30 minutes
SAME DRY INGRED. AS EXP. 15
DECREASE EGG WHITE TO 112 G
DECREASE BUTTER TO 112 G
LIQUIDS DO NOT COMPLETELY COMBINE
EVEN BETTER RESULTS
WHEN DRY ADDED TO LIQUID AND MIXED
DOUGH FORMS CRUMBLE STRUCTURE
FORM INTO DOUGH BALL FOR PAN AND
FOR MUFFIN TIN AND FORM LOAF BY HAND
THE FINAL PRODUCTS HAVE NICE RISE AND
SPREAD, TOP OF LOAF REMAINS ROUND
AND DOESN'T COLLAPSE. USED A KNIFE TO
PUT SLITS ACROSS TOP OF LOAF TO AID
IN SPREAD ON TOP
NICE DRY POROUS STRUCTURE WITH
GOOD GAS POCKETS THROUGHOUT
NICE CRUST ON OUTSIDE
BEST FINISHED LOOKING PRODUCT
GOOD SPREAD AND RISE IN LOAF AND MUFFIN.

TABLE 18
BASIC BAKED FOOD
May 13, 2009

| | | | BOUND WATER | BOUND WATER | TOTAL |
|---|---|---|---|---|---|
| INGREDIENTS | PERCENT | LAB | PERCENTAGE | WEIGHT | STARCH |
| ERYTHITOL | 0.00% | 0.00 | | | 0 |
| PSYLLIUM SEED | 26.07% | 59.18 | | | 0.59 |
| WHEY PROTIEN | 31.00% | 70.37 | | | 0 |
| CREAM OF TARTAR | 4.70% | 10.67 | | | 0 |
| BAKING SODA | 4.70% | 10.67 | | | 0 |
| SALT | 2.53% | 5.74 | | | 0 |
| STEVIA | 0.00% | 0.00 | | | 0 |
| CELLULOSE HP-8A | | 0.00 | | | 0 |
| PSYLLIUM HUSK | 31.00% | 70.37 | | | 0 |
| DRY INGREDIENT TOTAL | 100.00% | 227.00 | <1 | <1 | 0.59 |
| EGG WHITE (thick and thin albumin) | | 112.00 | 88.00% | 99 grams | |
| BUTTER | | 112.00 | 17.00% | 19 grams | |
| BOUND WATER TOTAL | 100.00% | 118.00 | | | |
| TOTAL DRY AND BOUND WATER | 100.00% | 345.00 | 34.00% | | |

350 degrees for 30 minutes
ELIMINATE CELLULOSE
REPLACE SOME HUSK WITH SEED PWDER
REPLACE APPROX, 10% OF HUSK
ANTICIPATED 30% HUSK IN SEED PWDER
EXPECT 17 G OF HUSK IN SEED POWDER
ADJUST WHEY DOWN TO ALLOW FOR
ADDED BULK OF SEED POWDER
MAINTAIN LIQUID PORTION OF EXP. 17
SEED POWDER APPEARS TO
ABSORB MORE LIQUID THAN JUST HUSK
FLUFFY CRUMB STRUCTURE WITH
MINIMAL GAS POCKET IN LOAF AND MUFFINS
DENSER CRUMB STRUCTURE AND FAR LESS
EXPANSION AND RISE THAN JUST HUSK
IT IS AS IF THE SEED POWDER
HAS ABSORBED MOST OF THE LIQUID
BEFORE IT CAN TURN TO STEAM TO INFLATE
AND FORM TRAPPED AIR POCKETS
FAR DRYER AND DENSE COMPRESSED
FLUFFED UP CRUMBS WITH ALMOST NO
TRAPPED AIR POCKETS INSIDE.
VERY MINIMAL PUFF AND SPREAD.
The balance of quantity of bound water to mucilage in the final product appears to determine the organoleptic characteristics where a denser baked food product might require less bound water in fat and egg albumin and be better with a dense crumb structure that has less mucilage a more fluffy baked food like a cake will probably require more mucilage husk and water with less psyllium kernal or other filler so that the mucilage can become more elastic and inflate more completely.

TABLE 19
STRAWBERRY-BANANA COOKIE

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 33.82% | 76.77 | | | 0 | |
| PSYLLIUM SEED | 29.58% | 67.15 | | | 0.67 | |
| WHEY PROTIEN | 7.48% | 16.98 | | | 0 | |
| CREAM OF TARTAR | 1.48% | 3.36 | | | 0 | |
| BAKING SODA | 1.56% | 3.54 | | | 0 | |
| SALT | 1.30% | 2.95 | | | 0 | |
| REB A | 0.35% | 0.79 | | | 0 | |
| CELLULOSE HP-8A | 1.51% | 3.43 | | | 0 | |
| STRAWBERRY FLAVOR | 8.64% | 19.61 | | | 0 | |
| BANANA FLAVOR | 8.17% | 18.55 | | | | |
| VANILLA FLAVOR | 6.11% | 13.87 | | | | |
| TOTALS | 100.00% | 227.00 | <1 | <1 | .67 | grams |
| EGG WHITE | | 33.00 | 88.00% | 29 grams | | |
| EGG YOLK | | 18.00 | 48.00% | 9 grams | | |
| BUTTER | | 85.00 | 17.00% | 15 grams | | |
| BOUND WATER TOTAL | 100.00% | 53.00 | | | | |
| TOTAL DRY AND BOUND WATER | 100.00% | 280.00 | 19% | | | |

350 degrees for 15 minutes
This cookie is currently in production and commercially being sold. Cookies are a very low moisture baked food product. This cookie has good rise and spread and organoleptic characteristics similar to conventional baked cookies but this cookie uses controlled hydration of a mucilaginous hydrocolloid to form the internal network from protein, fat and fiber instead of starch. The only starch is incidental to the psyllium plant and trace and not enough to impact the formation of the internal network of the baked food.

TABLE 20
COCOA-LICIOUS COOKIE

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 33.49% | 76.02 | | | 0 | |
| PSYLLIUM SEED | 29.29% | 66.49 | | | 0.66 | |
| WHEY PROTIEN | 7.41% | 16.82 | | | 0 | |
| CREAM OF TARTAR | 1.35% | 3.06 | | | 0 | |
| BAKING SODA | 1.37% | 3.54 | | | 0 | |
| SALT | 1.20% | 3.11 | | | 0 | |
| REB A | 0.35% | 0.79 | | | 0 | |
| CELLULOSE HP-8A | 1.46% | 3.31 | | | 0 | |
| COCOA POWDER | 8.30% | 18.84 | | | 0 | |
| CINNAMON GROUND | 2.00% | 4.54 | | | | |
| VANILLA FLAVOR | 13.78% | 31.28 | | | | |
| TOTALS | 100.00% | 227.00 | <1 | <1 | 0.66 | grams |
| EGG WHITE | | 33.00 | 88.00% | 29 grams | | |
| EGG YOLK | | 18.00 | 48.00% | 9 grams | | |
| BUTTER | | 85.00 | 17.00% | 15 grams | | |
| BOUND WATER TOTAL | 100.00% | 53.00 | | | | |
| TOTAL DRY AND BOUND WATER | 100.00% | 280.00 | 19% | | | |

350 degrees for 15 minutes
This cookie is currently in production and commercially being sold. Cookies are a very low moisture baked food product. This cookie has good rise and spread and organoleptic characteristics similar to conventional baked cookies but this cookie uses controlled hydration of a mucilaginous hydrocolloid to form the internal network from protein, fat and fiber instead of starch. The only starch is incidental to the psyllium plant and trace and not enough to impact the formation of the internal network of the baked food.

TABLE 21
CHEWY CHOCOLATY COCOA-LICIOUS COOKIE

| | | | BOUND WATER | BOUND WATER | TOTAL | |
|---|---|---|---|---|---|---|
| INGREDIENTS | PERCENT | LAB | PERCENTAGE | WEIGHT | STARCH | |
| ERYTHITOL | 20.09% | 45.60 | | | 0 | |
| PSYLLIUM SEED | 17.57% | 39.88 | | | 0.40 | |
| WHEY PROTIEN | 4.45% | 10.10 | | | 0 | |
| CREAM OF TARTAR | 0.80% | 1.82 | | | 0 | |
| BAKING SODA | 0.80% | 1.82 | | | 0 | |
| SALT | 0.72% | 1.63 | | | 0 | |
| REB A | 0.21% | 0.45 | | | 0 | |
| CELLULOSE HP-8A | 0.88% | 2.00 | | | 0 | |
| COCOA POWDER | 19.98% | 45.35 | | | 0 | |
| CINNAMON GROUND | 1.20% | 2.72 | | | | |
| VANILLA FLAVOR | 8.27% | 18.77 | | | | |
| INULIN | 20.00% | 46.00 | | | | |
| CHOCOLATE FLAVOR | 5.00% | 12.00 | | | | |
| TOTALS | 100.00% | 227.00 | <1 | <1 | 0.40 | grams |
| EGG WHITE | | 33.00 | 88.00% | 29 grams | | |
| EGG YOLK | | 18.00 | 48.00% | 9 grams | | |
| BUTTER | | 85.00 | 17.00% | 15 grams | | |
| BOUND WATER TOTAL | 100.00% | 53.00 | | | | |
| TOTAL DRY AND BOUND WATER | 100.00% | 280.00 | 19% | | | |

350 degrees for 15 minutes
The Cocoa-Licious Cookie in Table 20 was not as moist and chewy as customers prefer due to the high fiber cocoa powder. Also the extra fiber of the cocoa contributed to the flavor not dispersing during chewing and not carried as well as desired By adding inulin as a dough conditioner we've significantly increased the chewy, moistness of the cookie and been able to significantly increase the amount of cocoa powder to improve both flavor and texture without adding any ingredients that digest to glucose.

### Example 2

### Low-Starch, High-Fiber Food Products

Tables 19-21 are the formula of a banana-strawberry flavored cookie, a cocoa-flavored cookie and chewy chocolaty cocoa-flavored cookie, respectively. In Table 21, inulin was added to obtain a chewier, moister tasting cocoa cookie. By adding the soluble fiber inulin, it was possible to increase the amount of cocoa powder (an insoluble fiber) to 15% or greater, which in turn reduces the effective percentage of water since no additional water is added. These products have properties that are analogous to regular baked goods in terms of organoleptic properties such as mouth feel, crumble, dentation, taste profile, etc.

What is claimed is:

1. A method for producing a starch-free, high-fiber baked food product, comprising:
blending a fiber component comprising soluble, non-digestible hydrocolloid fibers, a protein component, a fat component and at least one additive to form a dough, wherein water addition is controlled in the blending process so that the soluble hydrocolloid fibers are partially hydrated to form an elastic internal network of mucilage,
baking the dough to allow the internal network to encapsulate hot gases released during the baking process to inflate the dough into a baked food product,
wherein the dough is free from digestible starch and gluten and is baked without the use of yeast.

2. The method of claim 1, wherein the partial hydration of the soluble hydrocolloid fibers is achieved with bound water in the protein component and the fat component and no additional water is added during the blending process.

3. The method of claim 1, wherein the fiber component consists essentially of psyllium fiber.

4. The method of claim 3, wherein the psyllium fiber is ground psyllium husk, ground whole psyllium seed or a mixture thereof.

5. The method of claim 4, wherein the psyllium fiber is a mixture of ground psyllium husk and ground whole psyllium seed.

6. The method of claim 3, wherein the partial hydration of the soluble hydrocolloid fibers is achieved by maintaining a fiber component-to-water weight ratio in the range of 1:0.6 to 1:3 in the dough, wherein the water includes bound water in the protein and fat components.

7. The method of claim 1, wherein the blending step comprises:
mixing dry ingredients together to form a dry mix;
mixing liquid ingredients together to form a liquid mix; and
blending the dry mix with the liquid mix to form a dough.

8. The method of claim 7, wherein the dry mix-to-liquid mix weight ratio is between 30:70 and 50:50.

9. The method of claim 1, wherein the protein component comprises egg white and whey protein.

10. The method of claim 1, wherein the fat component comprises butter.

11. The method of claim 1, wherein the at least one additive comprises erythritol or Rebaudioside A.

12. A high-fiber, low starch baked food product, comprising
a bulk texturing amount of protein and partially hydrated psyllium fiber,
wherein the partially hydrated psyllium fiber forms a gas-encapsulating and not fully gelatinized mucilaginous hydrocolloid network in the baked food product to provide consistency and texture similar in organoleptic characteristics to conventional baked products, and
wherein the baked food product is free from gluten and has a digestible starch content of less than 2%.

13. The baked product of claim 12, wherein the baked food product has a digestible starch content of less than 1%.

14. The baked product of claim 12, wherein the baked food product has a digestible starch content of less than 0.5%.

15. The baked product of claim 12, wherein the psyllium fiber is ground psyllium husk, ground whole psyllium seed or a mixture thereof.

16. The baked product of claim 12, comprising 20-40% psyllium fiber by weight.

17. The baked product of claim 12, having a digestible carbohydrate content of 10% or less by weight.

18. A low-starch, high-fiber baked food product, comprising:
3-30% protein by weight;
10-40% psyllium fiber by weight;
10-40% fat by weight;
at least one additive in the amount of 1-60% by weight; and
2-10% water by weight,
wherein the fiber and protein components provide bulk to support a structure of the baked food product, and wherein the baked food product has a digestible starch content of 2%© or less by weight and a digestible carbohydrate content of 10% or less by weight.

19. The low-starch, high-fiber baked food product of claim 18, wherein the baked food product has a digestible starch content of 1% or less by weight and a digestible carbohydrate content of 5% or less by weight.

20. The low-starch, high-fiber baked food product of claim 19, further comprising inulin in the amount of 1-20% by weight.
